(19) United States
(12) Patent Application Publication
(10) Pub. No.: US 2004/0141586 A1
(43) Pub. Date: Jul. 22, 2004

(54) Integral anatomical and functional computed tomography imaging system

(76) Inventors: Ching-Fu Hsieh, Taoyuan Hsien (TW); Yuh-Ren Shieh, Hsinchu Hsien (TW); Jang-Tzeng Lin, Hsinchu (TW); E-Chang Hsu, Hsinchu Hsien (TW)

Correspondence Address: SEYFARTH SHAW, 55 EAST MONROE STREET, SUITE 4200, CHICAGO, IL, 60603-5803, US

(21) Appl. No.: 10/435,877

(22) Filed: May 12, 2003

(30) Foreign Application Priority Data
Jan. 22, 2003 (TW) 092101428

(51) Int. Cl. G01N 23/04

(52) U.S. Cl. 378/63

(57) ABSTRACT

The present invention discloses an integral anatomical and functional computed tomography imaging system, which includes an x-ray source, a rotational stand for a sample and an imager. The imager includes an x-ray and a gamma-ray scintillator, an image sensor for detecting photon from the scintillator and a pinhole collimator positioned between the rotational stand and the scintillator. During the anatomical imaging process, the x-ray penetrating through the sample will directly irradiate on the scintillator in x-ray mode. During the functional imaging process, the gamma-ray emitted from the radioisotope-injected sample will penetrate through the pinhole of the pinhole collimator and then irradiate on the scintillator in gamma-ray mode. For both cases, photons are generated by the scintillator and picked up by the image sensor.

### BACKGROUND OF THE INVENTION

1. Field of the Invention

The present invention relates to a computed tomography imaging system, and more particularly, to an integral anatomical and functional computed tomography imaging system using a single image sensor.

2. Background of the Invention

Generally, during an animal experimentation for a new drug development and disease research, it is necessary to observe the anatomical and functional image of the animal sample to judge the relation of the drug and the disease. The computed tomography (CT) and the single photon emitting computed tomography (SPECT) are the most widely used techniques for anatomical and functional imaging, respectively.

The CT uses the x-ray irradiating sample to provide the anatomical image and the SPECT uses the gamma-ray of the radioisotope to generate the functional image. Since the radioactive drug possesses unique biochemical and pathological properties, the intake of the radioactive drug of a diseased organ is different from that of a normal organ. The intake of the radioactive drug of the diseased organ can be observed from the functional image, and the SPECT can provide the physiological image, such as the bone and the tissue, of the experimented animal.

FIG. 1 is a schematical diagram of a CT-SPECT system according to the prior art. The CT-SPECT system 10 comprises an x-ray source 12, a rotational stand 14 for a sample, an x-ray detector 16 and a gamma-ray detector 18. The x-ray detector 16 includes a scintillator 20 and a charge coupled device 22, and the gamma-ray detector includes a pinhole collimator 24 and a photomultiplier tube 26. The x-ray source 12 and the x-ray detector 16 are positioned on opposite sides of the rotational stand 14. The gamma-ray detector 18 and the x-ray detector 16 are positioned in a perpendicular manner to the rotational stand 14.

When an x-ray CT process is performed, the x-ray detector 16 records the intensity and position of x-ray penetrating through the sample to generate the anatomical image of the sample. When a SPECT process is performed, the gamma-ray detector 18 records the intensity and position of the gamma-ray emitted from the sample to generate functional image of the sample. An image registration process is performed to fuse the anatomical and functional image.

Since the anatomical image and the functional image are provided separately from the x-ray detector 16 and the gamma-ray detector 18, performing the image registration is troublesome, and errors tend to occur in the fused image which further increases the difficulty in reading the fused image.

### SUMMARY OF THE INVENTION

The object of the present invention is to provide an integral anatomical and functional computed tomography imaging system using a single image sensor.

In order to achieve the above-mentioned object and avoid the problems of the prior art, the present invention provides an integral anatomical and functional computed tomography imaging system that uses a single imager to combine the CT and the SPECT function. The integral anatomical and functional computed tomography imaging system comprises an x-ray source, a rotational stand for a sample and an imager. The imager comprises a scintillator for transforming x-ray and gamma-ray into photons, an image sensor for detecting photons from the scintillator and a pinhole collimator positioned between the rotational stand and the scintillator. During the anatomical computed tomography imaging process, the x-ray penetrating through the sample will directly irradiate on the scintillator in x-ray mode. During the functional computed tomography imaging process, a radioactive isotope is injected into the sample and the gamma-ray emitted from the radioisotope-injected sample will penetrate through the pinhole of the pinhole collimator and then irradiate on the scintillator in gamma-ray mode. Consequently, the present invention combines the CT with the SPECT to form an integral CT and SPECT system.

Compared with the prior art, the present invention uses a single imager to perform the anatomical and functional computed tomography, and therefore possesses the following advantages:

(1) Since the present invention uses the single imager design, it is not necessary to remove the sample during both the anatomical CT and the functional SPECT process, and the anatomical and functional image can be fused directly without image registration to avoid the error originating from the image registration.

(2) The photon transforming layer of the scintillator can be replaced to accommodate the integral system with photons of different energy so that the integral CT and SPECT system can provide the anatomical image with optimum resolution and sensitivity.

(3) The flexibility of replacing the photon transforming layer of the scintillator in combination with different pinhole diameters of the pinhole collimator can provide the functional image with optimum resolution and sensitivity.

### BRIEF DESCRIPTION OF THE DRAWINGS

Other objects and advantages of the present invention will become apparent upon reading the following description and upon reference to the accompanying drawings in which:

FIG. 1 is a schematic diagram of a CT-SPECT system according to the prior art;

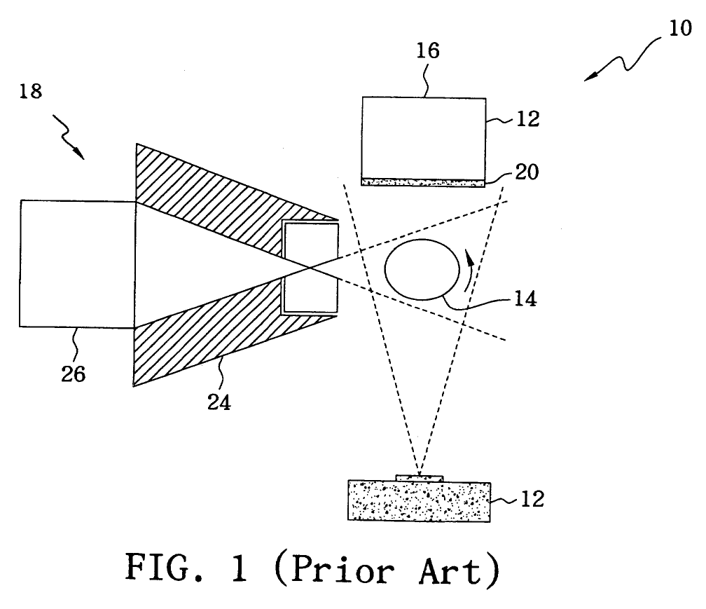

FIG. 2 is a schematic diagram of an integral anatomical and functional computed tomography imaging system according to the present invention when performing an anatomical imaging process;

FIG. 3 is a schematic diagram of the scintillator according to the present invention; and

FIG. 4 is a schematic diagram of an integral anatomical and functional computed tomography imaging system according to the present invention when performing a functional imaging process.

### PREFERRED EMBODIMENT OF THE PRESENT INVENTION

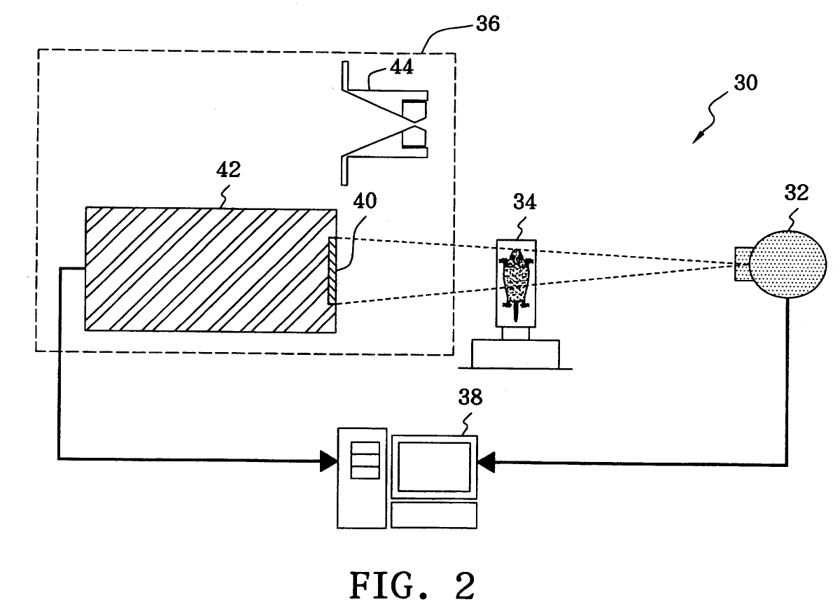

FIG. 2 is a schematic diagram of an integral anatomical and functional computed tomography imaging system 30 according to the present invention when performing an anatomical imaging process. The integral anatomical and functional computed tomography imaging system 30 comprises an x-ray source 32, a rotational stand 34 for a sample, an imager 36 and a computer 38 capable of controlling, imaging, reconstructing image and fusing image. The imager 36 comprises a scintillator 40 for transforming x-ray penetrating through the sample or gamma-ray emitted from the sample into photons, an image sensor 42 for detecting photons from the scintillator 40 and a pinhole collimator 44 positioned in a removable manner between the rotational stand 34 and the scintillator 40. The x-ray source 32 can be a transmission-anode x-ray tube or a conventional x-ray tube and the energy of x-ray is dependent on the size and material of the sample.

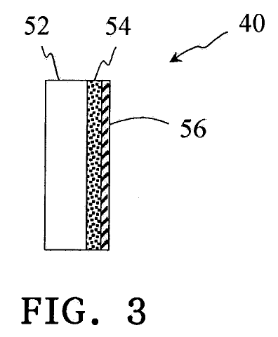

FIG. 3 is a schematic diagram of the scintillator 40 according to the present invention. The scintillator 40 comprises a transparent substrate 52 with low radiational decay ability, a photon transforming layer 54 with high transforming efficiency positioned on the transparent substrate 52 and an optical reflecting layer 56 positioned on the surface of the photon transforming layer 54. The x-ray or the gamma-ray irradiated on the photon-transforming layer 54 excites visible photons. The photon-transforming layer 54 can be made of cesium iodide or LSO. The transparent substrate 52 with low radiation decay ability is made of glass, fiberglass or acrylic, and used to support the photon-transforming layer 54. The optical reflecting layer 56 is made of aluminum or gold, and used for increasing the transforming efficiency. Dependent on the x-ray or gamma-ray with a variety of energy, the scintillator 40 can use a photon transforming layer 54 with different thickness, material and structure to provide an image with optimum resolution and sensitivity.

The image sensor 42 consists of the charge coupled device, the CMOS, and the image intensifier or the photodiode array, and can adjust the magnifying power of the signal to detect visible photons from the photon transforming layer 54. The pinhole diameter of the pinhole collimator 44 is in a range between 2 and 0.5 mm, and is preferably around 1 mm. The scintillator 40 and the pinhole collimator 44 are designed to be removable.

Please refer to FIG. 2. When the anatomical computed tomography imaging process is performed, the x-ray from the x-ray source 32 irradiates on the sample on the rotational stand 34, the scintillator 40 and the image sensor 42 cooperates with each other to detect the x-ray penetrating through the sample, and the computer 38 records the position and intensity of the penetrating x-ray to generate an anatomical image. During the anatomical computed tomography imaging process, it is not necessary to use the pinhole collimator 44, and the penetrating x-ray is irradiated directly on the scintillator 40 in x-ray mode.

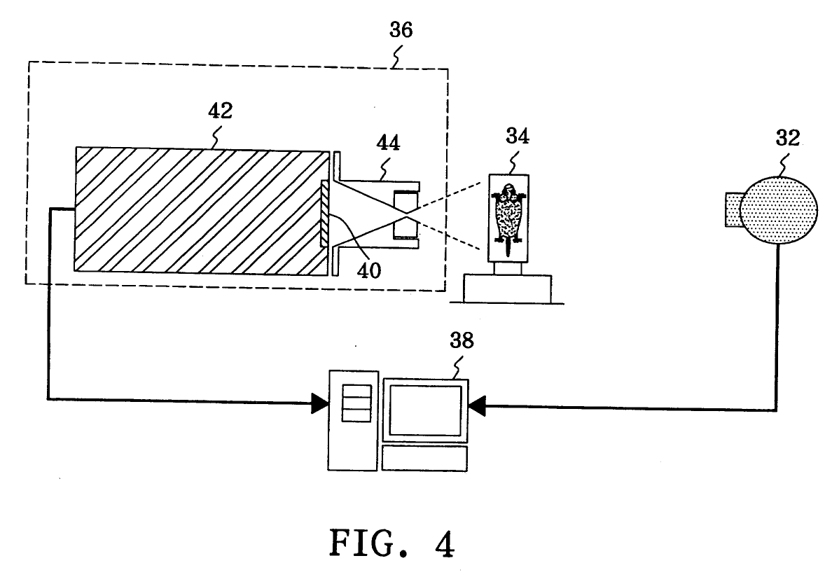

FIG. 4 is a schematic diagram of the integral anatomical and functional computed tomography imaging system 30 according to the present invention when performing a functional imaging process. When the functional computed tomography imaging process is performed, a radioactive isotope drug, capable of emitting gamma-ray such as 99 mTc, is first injected into the sample and the pinhole collimator 44 is positioned between the scintillator 40 and the sample. The gamma-ray emitted from the radioisotope-injected sample will penetrate through the pinhole of the pinhole collimator 44 and then irradiate on the scintillator 40 in gamma-ray mode. Unlike the anatomical computed tomography imaging process, the scintillator 40 used during the functional imaging process can use a single photon transforming layer with a larger thickness, but without the substrate and the optical reflecting layer. The scintillator 40, the pinhole collimator 44 and the image sensor 42 cooperates with each other to detect the gamma-ray emitted from the sample, and the computer 38 records the position and intensity of the gamma-ray to generate a functional image.

According to the disclosure of the present invention, it is not necessary to remove the sample during both the anatomical and the functional imaging process to perform the image registration, and the computer 38 can fuse the anatomical image and functional image directly. The following table compares the difference between the prior art and the present invention:

| | Prior art | Present invention |
|---|---|---|
| Modalities | Separated CT and | Single imager with different |
| | SPECT with | scintillators for anatomical and |
| | different imager | functional imaging |
| Characteristic | Image registration | Not necessary to remove sample |
| | required | and to perform image |
| | | registration |
| Imaging | ãnatomical imaging: | Integral anatomical and |
| device | x-ray scintillator | functional computed tomography |
| | image sensor | imaging system |
| | \tilde{f}unctional imaging: | x-ray/gamma-ray scintillator |
| | gamma-ray | imager/(pinhole collimator + image |
| | pinhole collimator | sensor) |
| | scintillator | |
| | photomultiplier tube | |

Compared with the prior art, the present invention uses a single imager to perform the anatomical and functional computed tomography, and therefore possesses the following advantages:

(1) Since the present invention uses the single imager design, it is not necessary to remove the sample during both the anatomical CT and the functional SPECT process, and the anatomical and functional image can be fused directly without image registration to avoid the error originating from the image registration.

(2) The photon transforming layer of the scintillator can be replaced to accommodate the integral system with photons of different energy so that the integral CT and SPECT system can provide the anatomical image with optimum resolution and sensitivity.

(3) The flexibility of replacing photon transforming layer of the scintillator in combination with different pinhole diameter of the pinhole collimator can provide the functional image with optimum resolution and sensitivity.

The above-described embodiments of the present invention are intended to be illustrative only. Numerous alternative embodiments may be devised by those skilled in the art without departing from the scope of the following claims.

What is claimed is:

1. An integral anatomical and functional computed tomography imaging system, comprising:
an x-ray source;
a rotational stand for supporting a sample, wherein the sample is injected with a radioisotope capable of emitting a gamma-ray during a functional computed tomography imaging process;
an imager, including:
a scintillator for transforming the x-ray and the gamma-ray into photons;
an image sensor for detecting photons from the scintillator; and
a pinhole collimator positioned between the scintillator and the rotational stand during the functional computed tomography imaging process; and
a computer connected to the imager for image processing.

2. The integral anatomical and functional computed tomography imaging system of claim 1, wherein the x-ray source is selected from the group consisting of a transmission-anode x-ray tube and a conventional x-ray tube.

3. The integral anatomical and functional computed tomography imaging system of claim 1, wherein the pinhole collimator is removable.

4. The integral anatomical and functional computed tomography imaging system of claim 1, wherein the pinhole diameter of the pinhole collimator is in the range of about 0.5 to 2 mm.

5. The integral anatomical and functional computed tomography imaging system of claim 1, wherein the pinhole diameter of the pinhole collimator is approximately 1 mm.

6. The integral anatomical and functional computed tomography imaging system of claim 1, wherein the scintillator is a photon-transforming layer.

7. The integral anatomical and functional computed tomography imaging system of claim 6, wherein the photon-transforming layer comprises a member selected from the group consisting of cesium iodide and LSO.

8. The integral anatomical and functional computed tomography imaging system of claim 7, wherein the photon-transforming layer is positioned on a substrate with low radiation decay ability.

9. The integral anatomical and functional computed tomography imaging system of claim 8, wherein the substrate is made of glass, fiberglass or acrylic.

10. The integral anatomical and functional computed tomography imaging system of claim 6, wherein the scintillator further comprises an optical reflecting layer positioned on the photon-transforming layer for increasing the transforming efficiency.

11. The integral anatomical and functional computed tomography imaging system of claim 10, wherein the optical reflecting layer comprises a member selected from the group consisting of aluminum and gold.

12. The integral anatomical and functional computed tomography imaging system of claim 1, wherein the image sensor is selected from the group consisting of a charge coupled device, a CMOS device, an image intensifier and a photodiode array.
